(19) United States
(12) Patent Application Publication
(10) Pub. No.: US 2020/0410365 A1
(43) Pub. Date: Dec. 31, 2020

(54) UNSUPERVISED NEURAL NETWORK TRAINING USING LEARNED OPTIMIZERS

(71) Applicant: GOOGLE LLC, Mountain View, CA (US)

(72) Inventors: Brian Cheung, Palisades Park, NJ (US); Jascha Narain Sohl-Dickstein, San Francisco, CA (US); Luke Shekerjian Metz, Mountain View, CA (US); Niruban Maheswaranathan, Mountain View, CA (US)

(21) Appl. No.: 16/975,949

(22) PCT Filed: Feb. 26, 2019
(86) PCT No.: PCT/US2019/019647

§ 371 Date: Aug. 26, 2020

Related U.S. Application Data
(60) Provisional application No. 62/635,424, filed on Feb. 26, 2018.

(51) Int. Cl. G06N 3/08; G06K 9/62; G06N 3/04; G06N 3/063

(52) U.S. Cl. CPC G06N 3/088; G06K 9/6256; G06N 3/084; G06N 3/0454; G06N 3/063; G06N 3/0481

(57) ABSTRACT

Methods, systems, and apparatus, including computer programs encoded on computer storage media, for training a base neural network that generates numeric representations of network inputs.

### BACKGROUND

This specification relates to training a neural network and, in particular, to training a neural network for generating numeric representations of data items, e.g., images.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system that trains a base neural network that generates numeric representations of input data items. In particular, the system determines updates to the parameters of the base neural network during the training by making use of an update neural network instead of computing gradients as is conventionally done.

Particular embodiments of the subject matter described in this specification can be implemented so as to realize one or more of the following advantages.

By training a base neural network as described in this specification, the quality of the representations generated by the base neural network can be improved relative to conventional approaches, i.e., because the updates to the parameters of the base neural network are determined using a learned optimizer, i.e., an update neural network.

Additionally, the optimizer can be learned jointly with a smaller neural network and then used to train a larger neural network, reducing the amount of computational resources necessary to learn the optimizer. That is, the optimizer can be learned in a computationally efficient manner even when used to determine updates to neural networks having large numbers of parameters. Further, once learned, the optimizer generalizes not only across network architectures, i.e., the same learned optimizer can be used to train base networks with different architectures, but also across a wide array of datasets, i.e., can be used to train a network to generate representations of a variety of different inputs drawn from various data distributions. Thus, after being learned, the optimizer can be applied for multiple different tasks without needing to be re-trained, minimizing the amount of computational resources consumed by the system.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a diagram illustrating the training of the base neural network and the update neural network.

FIG. 3 is a diagram showing a more detail view of the inner loop and the outer loop of the training.

FIG. 4 is a flow diagram of an example process for training the base neural network.

FIG. 5 is a flow diagram of an example process for training the update neural network.

Like reference numbers and designations in the various drawings indicate like elements.

### DETAILED DESCRIPTION

This specification describes a system implemented as computer programs on one or more computers in one or more locations that trains a base neural network that is configured to generate numeric representations of network inputs. A numeric representation is an ordered collection of numeric values, e.g., a vector of floating point or quantized floating point values, having a pre-determined dimensionality, i.e., each representation has the same pre-determined number of numeric values.

The base neural network can be configured to receive any kind of digital data input and to generate a numeric representation of the input. For example, the inputs to the neural network can be images. As another example, the inputs to the neural network can be pieces of text, e.g., words, sentences or other collections of multiple words, or entire documents. As another example, the inputs to the neural network can be Internet resources, e.g., web pages.

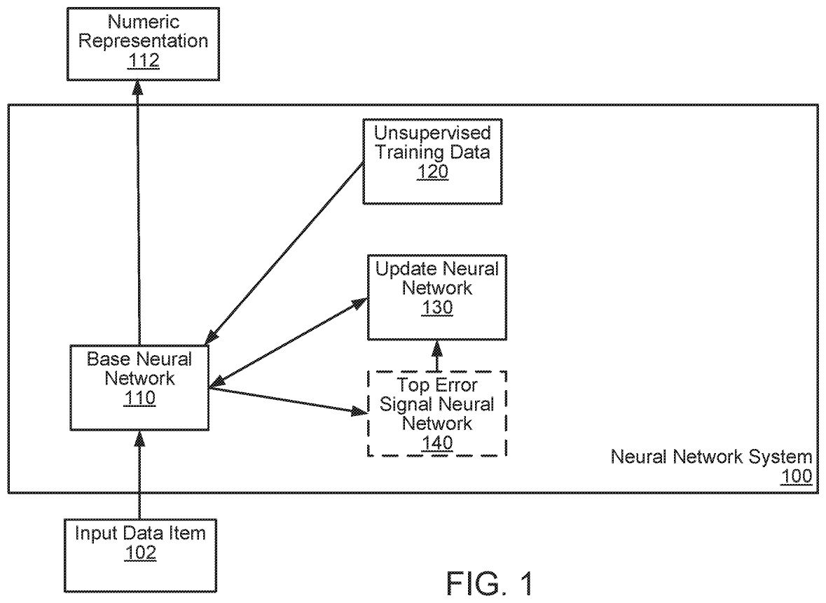

FIG. 1 shows an example neural network system 100. The neural network system 100 is an example of a system implemented as computer programs on one or more computers in one or more locations, in which the systems, components, and techniques described below can be implemented.

The neural network system 100 trains a base neural network 110 that is configured to generate numeric representations of network inputs. In other words, the base neural network 110 is configured to receive a network input 102 and to generate as output a numeric representation 112 of the network input.

The base neural network 110 can have any architecture that is appropriate for transforming network inputs of the type that the network 110 is configured to receive into numeric representations having the pre-determined dimensionality.

For example, when the network inputs are images, the base neural network 110 can be a convolutional neural network or a fully-connected network, e.g., a multi-layer perceptron (MLP) that operates on the intensity values of the image pixels. As another example, when the network inputs are words, the base neural network 110 can be a fully-connected neural network. As another example, when the network inputs are sequences of texts, e.g., text from a resource, the base neural network 110 can be a self-attention-based encoder neural network.

Generally, however, the base neural network 110 has a plurality of layers arranged according to a processing order, i.e., arranged into an architecture that defines which neurons receive inputs from which other neurons and where each neuron provides outputs generated by the neuron during the processing of a network input. Each layer has one or more neurons and each neuron has a respective plurality of neuron parameters.

The neural network system 100 trains the base neural network 110 on unsupervised training data 120 to repeatedly update the values of the neuron parameters of the neurons of the base neural network 110, i.e., to generate trained values of the neuron parameters from initial values.

The training data 120 is referred to as unsupervised training data because the training network inputs in the training data 120 are either (i) not associated with any labels for any machine learning tasks or (ii) the labels are not used in updating the values of the parameters of the base neural network 110 during the training. In other words, ground truth or target, i.e., known, outputs for any machine learning task for which the numeric representations will be used are either not available or not used when determining the updates to the neuron parameter values.

More specifically, during the training of the base neural network 110 on the unsupervised training data 120, the system 100 determines updates to the values of the parameters of the base neural network using an update neural network 130, i.e., instead of backpropagating gradients of some objective function as is conventionally done. Thus, the system 100 trains the base neural network 110 using a learned optimizer, i.e., the update neural network 130.

The update neural network is a neural network having parameters (referred to in this specification as “update parameters”) that is configured to process an update input including the outputs (“activations”) generated by a given neuron during processing of a batch of network inputs to generate an update output that defines at least a portion of the update to the neuron parameters of the given neuron. Because the update neural network generates outputs that define updates on an individual neuron basis, the same update neural network can be used for base neural networks having different architectures.

The update neural network 130 (and, when used, a top error signal neural network 140) is either trained jointly with the base neural network 110 by the system 100 or has already been trained jointly with another neural network that also generates the same kind of numeric representations as the base neural network 110.

Generally, the update neural network 130 is trained so that the updates generated using the update neural network 130 encourage the quality of the numeric representations to improve.

More specifically, the update neural network 130 is trained using supervised learning on an objective, referred to in this description as a MetaObjective, that measures the quality of generated representations when used as representations of network inputs for a machine learning task, e.g., supervised or semi-supervised classification, supervised or semi-supervised regression, or another supervised or semi-supervised task. Thus, updates to the parameters of the update neural network 130 are determined based on how well the generated representations represent the network inputs when used for a target task.

In particular, to evaluate MetaObjective, the system performs a machine learning task on a set of training inputs and their associated target outputs using numeric representations generated by the base neural network 110. The system then evaluates MetaObjective, which measures how well the numeric representations generated by the base neural network 110 perform when used for the machine learning task.

For example, the machine learning task can be a few-shot classification task. In such a task, the system fits a linear regression that maps from numeric representation to labels using one set of K training items and corresponding labels and then evaluates the performance (i.e., evaluates MetaObjective) based on how well the linear regression predicts the label for another set of K training items. For example, MetaObjective can be a distance metric between each predicted label using the linear regression and the actual label for the corresponding training item.

As another example, the MetaObjective can be a measure of similarity between numeric representations relative to their labels, e.g., a pair-wise loss, a triplet loss, a hinge loss, or other loss that penalizes numeric representations of network inputs having different labels being closer to one another in the numeric representation space.

Thus, the optimizer is learned, i.e., the update neural network 130 is trained, so that the updates to the base network parameters as defined by the outputs of the update neural network 130 directly improve the quality of the generated representations on the task for which they are intended to be used.

Additionally, although the update neural network is trained using MetaObjective that evaluates performance on one machine learning task, the trained base neural network can later be used to generate numeric representations of inputs for a similar but different machine learning task, e.g., a more complex classification task or a different task that depends on numeric representations being similar for inputs that belong to the same class.

Once the base neural network 110 has been trained to determine the trained values of the neuron parameters, the system can (i) process new network inputs using the trained base neural network in accordance with the trained values of the neuron parameters to generate respective numeric representations for each of the new network inputs, (ii) output data specifying the trained base neural network, i.e., to a user of the system 100 or to an external system, or (iii) both.

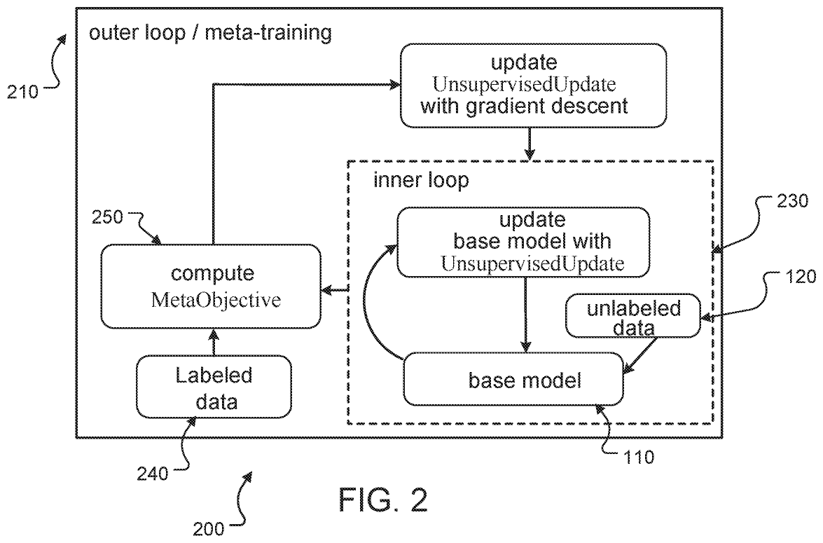

FIG. 2 is a diagram 200 illustrating the training of the base neural network 110 and the update neural network 130. The base neural network 110 is referred to as a “base model” and the update neural network 130 is referred to as “UnsupervisedUpdate” in the Figure.

FIG. 2 illustrates that the update neural network is trained in an outer loop 210 while the base neural network is trained in an inner loop 230.

After the update neural network has been trained using the outer loop 210, the process illustrated in FIG. 2 can be performed with a different base neural network with only the inner loop 230 and without the outer loop 210. That is, the process can be performed to only train the different base neural network without training the update neural network, i.e., while holding the trained values of the update network parameters fixed.

In particular, when both the outer loop and the inner loop are being performed, the system has access to target outputs, e.g., labels, for the unsupervised training items used to train the base neural network but does not use the target outputs when updating the base network parameters in the inner loop 230. Instead, the system only uses the target outputs when training the update neural network in the outer loop 210. When the outer loop 210 is not performed, the system does not need to have access to any target outputs for any of the training items and no target outputs are used in the training, i.e., the inner loop 230 can be repeatedly performed in an entirely unsupervised manner.

The different base neural network can be a neural network that generates the same type of numeric representations of the same type of network inputs, but has a different architecture from the base neural network that was used in training the update neural network. For example, the different base neural network can have an architecture that is more computationally expensive than the original base neural network that was used in training the update neural network. Thus, the trained update neural network can be re-used without additional training to train base neural networks on different data sets or to train base neural networks having different architectures. This ability to generalize reduces the amount of computational resources, e.g., processor cycles, consumed in training base neural networks to generate high-quality numeric representations.

In the inner loop 230, the base neural network 110 is trained on the unsupervised training data 120 (referred to as “unlabeled data”), and the parameters of the base neural network 110 are updated using the update neural network 130, in accordance with whatever the current values of the update network parameters are at the current iteration of the inner loop 230. Thus, during a given iteration of the inner loop 230, the base neural network 110 is used to process a batch of training network inputs and the various outputs generated by the neurons of the base neural network during the processing are used by the update neural network 130 to determine the updates to the neuron parameters values for the iteration.

In the outer loop 210, the update neural network is trained using supervised learning on labeled data 240. In particular, the MetaObjective 250 is evaluated using one or more batches of supervised training inputs and the system updates the current values of the parameters of the update neural network using gradient descent, i.e., by computing a gradient of the MetaObjective 250 with respect to each of the update network parameters. As will be described in more detail below, the gradients can be computed through the updates computed in one or more iterations of the inner loop 230 using truncated backpropagation.

Thus, during the training process shown in FIG. 2, the system repeatedly alternates between the inner loop 230 and the outer loop 210, i.e., between updating the parameters of the base network and the update network.

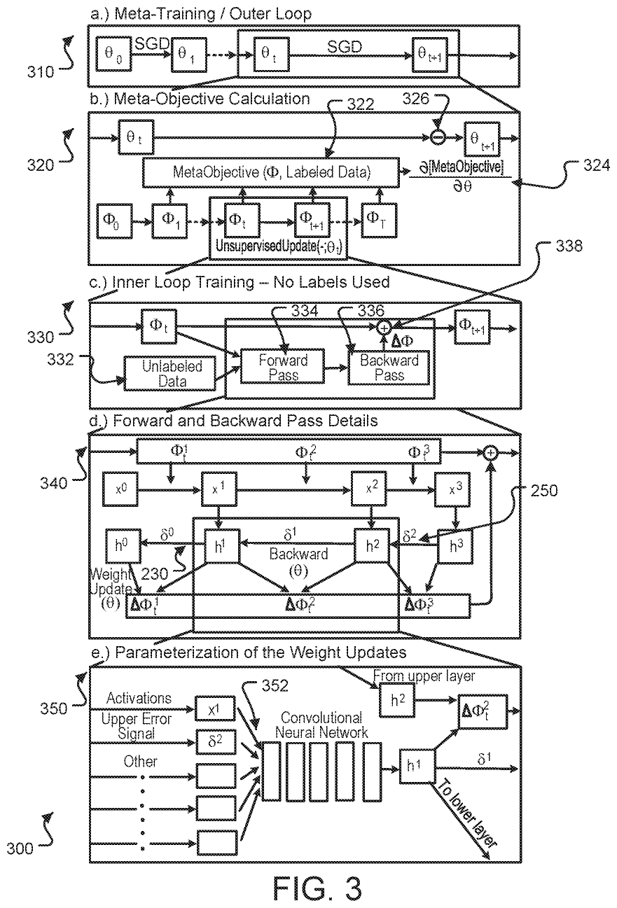

FIG. 3 is a diagram 300 showing a more detailed view of the outer loop and the inner loop.

In particular, part 310 of FIG. 3 shows the outer loop of the training process. At each iteration of the outer loop (referred to as an outer loop iteration), the meta-parameters θ, i.e., the parameters of the update neural network and any other parameters that define how the base network parameters are updated at any given iteration of the inner loop (e.g., the parameters of the top error signal neural network), are updated using gradient descent. Thus, the meta-parameters are repeatedly updated by performing multiple outer loop iterations.

Part 320 of FIG. 3 shows the updating of the meta-parameters θ at an outer loop iteration t. As shown in the example of FIG. 3, there are four iterations of the inner loop (referred to as inner loop iterations) between each outer loop iteration. Thus, at each outer loop iteration, the MetaObjective is evaluated for a set of supervised inputs. For example, when MetaObjective is the few shot classification objective, the linear regression can be fit using one batch of training inputs and then evaluated for another. In some cases, the two batches used in the MetaObjective evaluation are sampled from the four batches used in the four inner loop iterations while in other cases they are sampled from the entire training data set.

At each inner loop iteration, the corresponding batch of training network inputs is processed using the base neural network to generate respective numeric representations for each of the training network inputs in the batch and the parameters of the base neural network φ are updated using the current values of the meta-parameters as of the outer loop iteration t.

The MetaObjective is then evaluated and the gradient 322 of the MetaObjective with respect to the meta-parameters is determined by backpropagation through the unrolled application of the update neural network at the four inner loop iterations, i.e., using truncated backpropagation. The gradient 322 is then used to update 324 the values of the meta-parameters to generate the meta-parameter values θₜ₊₁ for the next outer loop iteration t+1.

Thus, in the description of FIG. 3, there are four updates to the base network parameters φ for each update to the meta-parameters θ.

Part 330 shows the updating of the base network parameters at inner loop iteration t. As shown in part 330, a batch of unlabeled training inputs 332 is processed using the base neural network in accordance with the current values of the neuron parameters to generate respective numeric representations for the training inputs in the batch. This is referred to as the “forward pass” 334. In the “backward pass” 336, the outputs generated by each of the neurons for the network inputs in the batch are used to generate updates to the neuron parameter values. This is done using the update neural network and in accordance with the meta-parameter values at outer loop iteration t. The updates are then applied 338 to the current neuron parameter values to generate the neuron parameter values φₜ₊₁ for inner loop iteration t+1.

Part 340 shows a more detailed view of the forward pass 334 and the backward pass 336. In the simplified example shown in FIG. 3 and for ease of explanation, the base neural network is assumed to have three layers 1, 2, 3 arranged in sequence. In practice, the operations shown in FIG. 3 can be performed for many more layers.

In particular, during the forward pass 334, an unlabeled training input batch x0 is received and processed through each of the layers 1, 2, and 3 to generate outputs x1, x2, and x3, respectively, where x3 are the numeric representations for the training input batch x0.

During the backward pass 336 and starting from the last layer in the base neural network, an update is determined for each neuron in the layer based on the outputs (“activations”) generated by the neurons in the layer and an error-signal for the neurons in the layer. The combination, e.g., concatenation, of these update outputs for all of the neurons in the layer is referred to as a hidden state for the layer. For each layer other than the top layer (i.e., the last layer in the processing order), the error-signal is generated from the hidden state for the layer after the layer in the processing order. In other words, the update outputs for the neurons in a given layer define the error-signal for the layer below the given layer in the processing order.

In some implementations, the error signal for the top layer is determined using the top error signal neural network. Thus, the top error signal neural network is a neural network that has parameters (referred to as “top error signal parameters”) and is configured to process the numeric representations for the inputs in the batch in accordance with current values of the error signal parameters to generate the error signals for the top layer. The error signal parameters can be updated along with the update network parameters as part of the outer loop. For example, the top error signal neural network can be a neural network that operates over every dimension of the numeric representations. For example, the neural network can include one or more convolutions over the internal dimensions of the numeric representations and one or more convolutions over the batch dimension.

In some other implementations, no top error signal neural network is used and the error signal for the top layer is a pre-determined placeholder error-signal.

For each layer, the update to the neuron parameters for the neurons in the layer is then determined (at least in part) from the hidden state for the layer and the hidden states for the neurons in the layer above the layer in the processing order.

Part 350 shows the updating of the neuron parameters in more detail.

In particular, in the example of FIG. 3, the update neural network is a convolutional neural network that is configured to receive an update input that includes the activations generated by a given neuron in a given layer during processing of a batch of training network inputs by the batch neural network and to process the update input in accordance with the update parameters to generate an update output for the given neuron that defines at least a portion of an update to the values of the neuron parameters of the given neuron. Like the top error signal neural network, the update neural network can be a neural network that operates over every dimension of the activations and the other components of the update input.

In particular, the activations generated by a given neuron that are included in the update input can include both the pre-nonlinearity activations of the neuron and the post-nonlinearity activations of the neuron. The post-nonlinearity of the neuron is the output generated by the neuron after the neuron has applied a non-linear activation function, e.g., sigmoid, tan h, or reLu, to the pre-nonlinearity activation of the neuron. When the neuron is configured to apply batch normalization, the pre-nonlinearity activation can be after batch normalization has been applied.

The update input also includes an “upper error signal” that is derived from the hidden states h for the neurons in the layer after the layer in the processing order (if the given layer is not the last layer in the processing order). In particular, the update outputs for the neurons in the above layer can define an initial error signal. For example, the initial error signal can be a concatenation of the update outputs. A backward weight matrix corresponding to the layer can be applied to the initial error signal as part of generating the upper error signal for the layer. The backward weight matrices for each layer can also be updated using the update neural network in the same way as the neuron parameters.

The update input can optionally also include one or more “other” terms that can improve the quality of the representations generated by the base neural network. For example, the update input can include one or more terms defining lateral interactions between neurons in the particular layer.

The system can compute the update to the neuron parameters of the neuron in a given layer from the hidden state for the neurons in the given layer and the neurons in the layer above the given layer in the processing order. In particular, the update can be a weighted mixture of multiple low-rank readouts from these hidden states, with the weight being learned as part of the outer loop.

In some implementations, for each layer, the update to the neuron parameters of the neurons in the layer is also based on one or more other terms that constrain the updates generated from the hidden states of the update neural network.

For example, the other terms can include decorrelation terms that (i) encourage outputs of different neurons in the particular layer to be decorrelated, that (ii) encourage receptive fields of neurons in the particular layer to be decorrelated, or (iii) both.

As another example, for each layer, the other terms can include one or more local terms that are a basis function representation of a change in the neuron parameters as a function of the activations of the neuron and the current values of the neuron parameters. When the updates are also based on these other terms, the individual updates computed from each other term and the update based on the hidden states can be normalized, reweighted, and merged to generate the final update.

In some implementations, the training of the base neural network and the update neural network is distributed across multiple devices. In these cases, when performing an iteration of the outer loop, some of the devices may train on base neural networks having different architectures, or on different data sets, or both than other devices in order to improve the ability of the trained update neural network to generalize to different data sets and to different architectures. For example, at each iteration of the outer loop, each device can sample a base network architecture and data set from a predetermined set of architectures and a predetermined larger pool of data and then use the architecture and data set to compute an update to the meta-parameters. This can encourage the trained update neural network to generalize to different architectures and different data sets not used in the training.

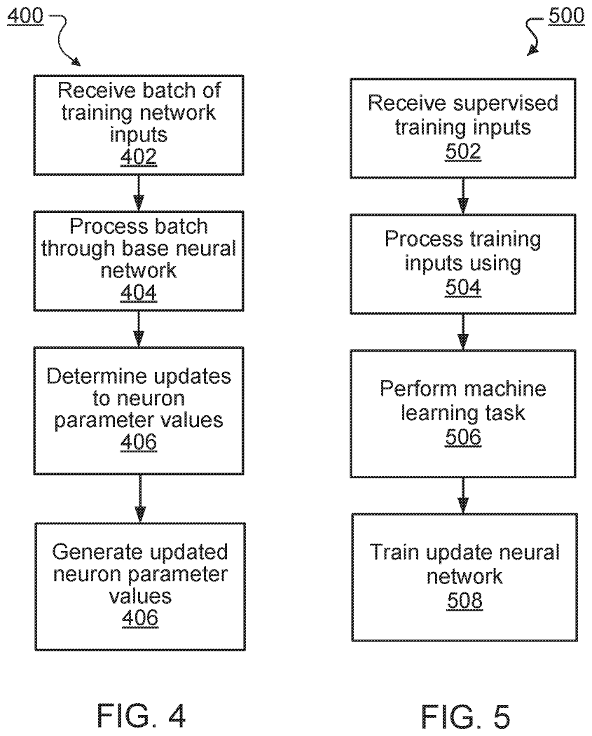

FIG. 4 is a flow diagram of an example process 400 for training the base neural network. For convenience, the process 400 will be described as being performed by a system of one or more computers located in one or more locations. For example, a neural network system, e.g., the neural network system 100 of FIG. 1, appropriately programmed, can perform the process 400.

The system can repeatedly perform the process 400, i.e., until termination criteria are satisfied, to train the base neural network by determining trained values of the neuron parameters for the neurons in the layers of the base neural network. For example, the termination criteria can be satisfied after a pre-determined number of iterations have been performed, after a pre-determined amount of time has elapsed, or after the changes to the neuron parameter values between iterations have fallen below a threshold.

The system receives a batch of training inputs (step 402).

The system processes a batch of training network inputs through the layers of the base neural network and in accordance with current values of the neuron parameters of the neurons to generate a respective numeric representation of each training network input (step 404).

The system determines, for each particular neuron in each particular layer of the base neural network, an update to the current values of the neuron parameters for the particular neuron using the update neural network (step 406).

In particular, as described above, the system processes an update input that includes activations generated by the particular neuron during the processing of the batch of training network inputs using the update neural network in accordance with current values of the update parameters to generate an update output for the neuron that defines at least a portion of the update to the current values of the neuron parameters for the particular neuron. For example, the update to the current values of the neuron parameters for a given neuron in a given layer can be defined based on the update output, the update outputs for the neurons in the layer above the given layer and, optionally, one or more local terms.

The system generates, for each particular neuron in each particular layer of the base neural network, updated values of the neuron parameters for the particular neuron from the update for the neuron parameters for the particular neuron and the current values of the neuron parameters for the particular neuron (step 408). For example, the system can add the update to the current values of the neuron parameters to generate the updated values or can update the current values by applying a moving average of the determined updates.

FIG. 5 is a flow diagram of an example process 500 for training the update neural network. For convenience, the process 500 will be described as being performed by a system of one or more computers located in one or more locations. For example, a neural network system, e.g., the neural network system 100 of FIG. 1, appropriately programmed, can perform the process 500.

The process 500 corresponds to one outer loop iteration of the outer loop as described above. The system can repeatedly perform the process 500 to repeatedly update the parameters of the update neural network and any other meta-parameters in the outer loop.

The system obtains a plurality of supervised network inputs and, for each of the supervised network inputs, a corresponding target output for a machine learning task (step 502). In other words, the system obtains a plurality of labeled training inputs. For example, these can be one or more batches of training inputs used in training the base neural network, but with associated labels, i.e., with corresponding target outputs. The system processes each of the supervised network inputs using the base neural network to generate a respective numeric representation of each of the supervised network inputs (step 504). For example, the system can process each of the one or more batches to generate the numeric representations as part of training the base neural network as described above. That is, the system can process the network inputs as part of performing one or more inner loop iterations to update the base network parameters.

The system performs the machine learning task on the respective numeric representations to generate task outputs for the supervised network inputs and trains the update neural network using supervised learning on an objective that evaluates a quality of the generated task outputs relative to the corresponding target outputs to determine the update to the current values of the update parameters (steps 506 and 508).

In particular, the system evaluates the MetaObjective and then computes gradients of the MetaObjective with respect to the parameters of the update neural network and any other meta-parameters of the outer loop, e.g., the parameters of the top error signal neural network, when used. The system can then update the meta-parameters using the learning rule employed by the gradient descent procedure used to train the model, e.g., by multiplying each gradient by a learning rate and then adding or subtracting the result from the current values of the meta-parameters.

The system can compute these gradients by backpropagating through the updates computed for the supervised network inputs during training of the base neural network. This can be done using truncated backpropagation, i.e., the system can backpropagate only through the k iterations of the inner loop that occur between iterations of the outer loop.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers. The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for training a base neural network, the method comprising:
receiving unsupervised training data for training a base neural network to generate numeric representations of network inputs, the base neural network having a plurality of layers arranged according to a processing order, each layer having one or more neurons, each neuron having a respective plurality of neuron parameters, and the training data comprising a plurality of training network inputs; and
training the base neural network on the unsupervised training data to determine trained values of the neuron parameters of the neurons of the base neural network from initial values of the neuron parameters, comprising:
during the training, determining updates to values of the neuron parameters using an update neural network that has a plurality of update parameters and that is trained to generate updates to the values of the neuron parameters that maximize the quality of the numeric representations generated by the base neural network when the numeric representations are used as representations of network inputs for a particular machine learning task.

2. The method of claim 1, wherein the update neural network is configured to receive an update input comprising activations generated by a given neuron during processing of a batch of training network inputs by the batch neural network and to process the update input in accordance with the update parameters to generate an update output for the given neuron that defines at least a portion of an update to the values of the neuron parameters of the given neuron.

3. The method of claim 2, wherein the training comprises:
processing a batch of training network inputs through the plurality of layers and in accordance with current values of the neuron parameters of the neurons to generate a respective numeric representation of each training network input;
for each particular neuron in each particular layer of the base neural network, determining an update to the current values of the neuron parameters for the particular neuron, comprising:
processing an update input that includes activations generated by the particular neuron during the processing of the batch of training network inputs using the update neural network in accordance with current values of the update parameters to generate an update output for the neuron that defines at least a portion of the update to the current values of the neuron parameters for the particular neuron; and
for each particular neuron in each particular layer of the base neural network, generating updated values of the neuron parameters for the particular neuron from the update for the neuron parameters for the particular neuron and the current values of the neuron parameters for the particular neuron.

4. The method of claim 3, wherein the update output for each particular neuron in each particular layer also defines an initial error signal for the neurons in the layer before the particular layer in the processing order.

5. The method of claim 4, wherein the update input for each particular neuron in each particular layer further comprises an error signal input derived from error signals for the neurons in the particular layer, and wherein the error signals for each layer other than the top layer are generated from the initial error signals defined by the update outputs for neurons in the layer after the layer in the processing order.

6. The method of claim 5, the training further comprising:
generating the error signals for the last layer in the processing order by processing the numeric representations for the training inputs in the batch using a top error signal neural network having a plurality of error signal parameters that is configured to process the numeric representations in accordance with current values of the error signal parameters to generate the error signals.

7. The method of claim 5, wherein the error signals for the last layer in the processing order are predetermined placeholder error signals.

8. The method of claim 1, wherein the update input for each neuron comprises the pre-nonlinearity activations of the neuron and the post-nonlinearity activations of the neuron.

9. The method of claim 8, wherein for one or more of the layers in the base neural network, the pre-nonlinearity activations of the neurons in the layer are activations after batch normalization has been applied.

10. The method of claim 1, wherein, for each particular layer other than the last layer in the processing order, the update to the neuron parameters of the neurons in the particular layer is based on the output of the update neural network for the neuron and the outputs of the update neural network for neurons in the layer after the particular layer in the processing order.

11. The method of claim 1, wherein the corresponding input for each neuron comprises one or more terms defining lateral interactions between neurons in the particular layer.

12. The method of claim 1, wherein, for each layer, the update to the neuron parameters of the neurons in the layer is based on one or more decorrelation terms that (i) encourage outputs of different neurons in the particular layer to be decorrelated, that (ii) encourage receptive fields of neurons in the particular layer to be decorrelated, or (iii) both.

13. The method of claim 1, wherein, for each layer, the update to the neuron parameters of the neurons in the layer is based on one or more local terms that are a basis function representation of a change in the neuron parameters as a function of the activations of the neuron and the current values of the neuron parameters.

14. The method of claim 1, wherein the update neural network has been trained using supervised learning to determine the current values of the update parameters.

15. The method of claim 14, wherein the update neural network has been trained using supervised learning to improve the quality of numeric representations generated by the base neural network or another neural network when used as a representation of network inputs for the machine learning task.

16. The method of claim 15, wherein the update neural network has been trained on a supervised objective that evaluates the quality of numeric representations when used as a representation of network inputs for the machine learning task.

17. The method of claim 1, wherein the update neural network has been trained jointly with a different neural network having a different architecture from the base neural network that also generates numeric representations of network inputs.

18. The method of claim 3, further comprising:
determining an update to the current values of the update parameters, comprising:
obtaining a plurality of supervised network inputs and, for each of the supervised network inputs, a corresponding target output for a machine learning task;
processing each of the supervised network inputs using the base neural network to generate a respective numeric representation of each of the supervised network inputs;
performing the machine learning task on the respective numeric representations to generate task outputs for the supervised network inputs; and
training the update neural network using supervised learning on an objective that evaluates a quality of the generated task outputs relative to the corresponding target outputs to determine the update to the current values of the update parameters.

19. The method of claim 18, wherein training the update neural network using supervised learning on the objective comprises training the update neural network using truncated backpropagation.

20. The method of claim 1, further comprising:
processing new network inputs using the trained base neural network in accordance with the trained values of the neuron parameters to generate respective numeric representations for each of the new network inputs.

21. The method of claim 1, further comprising:
outputting data specifying the trained base neural network.

22. A system comprising one or more computers and one or more storage devices storing instructions that when executed by the one or more computers cause the one or more computers to perform operations for training a base neural network, the operations comprising:
receiving unsupervised training data for training a base neural network to generate numeric representations of network inputs, the base neural network having a plurality of layers arranged according to a processing order, each layer having one or more neurons, each neuron having a respective plurality of neuron parameters, and the training data comprising a plurality of training network inputs; and
training the base neural network on the unsupervised training data to determine trained values of the neuron parameters of the neurons of the base neural network from initial values of the neuron parameters, comprising:
during the training, determining updates to values of the neuron parameters using an update neural network that has a plurality of update parameters and that is trained to generate updates to the values of the neuron parameters that maximize the quality of the numeric representations generated by the base neural network when the numeric representations are used as representations of network inputs for a particular machine learning task.

23. One or more non-transitory computer-readable storage media storing instructions that when executed by one or more computers cause the one or more computers to perform operations for training a base neural network, the operations comprising:
receiving unsupervised training data for training a base neural network to generate numeric representations of network inputs, the base neural network having a plurality of layers arranged according to a processing order, each layer having one or more neurons, each neuron having a respective plurality of neuron parameters, and the training data comprising a plurality of training network inputs; and
training the base neural network on the unsupervised training data to determine trained values of the neuron parameters of the neurons of the base neural network from initial values of the neuron parameters, comprising:
during the training, determining updates to values of the neuron parameters using an update neural network that has a plurality of update parameters and that is trained to generate updates to the values of the neuron parameters that maximize the quality of the numeric representations generated by the base neural network when the numeric representations are used as representations of network inputs for a particular machine learning task.
